(19) United States
(12) Patent Application Publication
(10) Pub. No.: US 2020/0387444 A1
(43) Pub. Date: Dec. 10, 2020

(54) EXTENDED MEMORY INTERFACE

(71) Applicant: Micron Technology, Inc., Boise, ID (US)

(72) Inventors: Vijay S. Ramesh, Boise, ID (US); Allan Porterfield, Durham, NC (US)

(21) Appl. No.: 16/433,698

(22) Filed: Jun. 6, 2019

(51) Int. Cl. G06F 12/02; G06F 3/06

(52) U.S. Cl. CPC G06F 12/0246; G06F 3/064; G06F 2212/7208; G06F 3/0679; G06F 3/061; G06F 3/0659

(57) ABSTRACT

Systems, apparatuses, and methods related to an extended memory communication subsystem for performing extended memory operations are described. An example apparatus can include a plurality of computing devices coupled to one another. Each of the plurality of computing devices can include a processing unit configured to perform an operation on a block of data in response to receipt of the block of data. Each of the plurality of computing devices can further include a memory array configured as a cache for the processing unit. The example apparatus can further include a first communication subsystem within the apparatus and coupled to the plurality of computing devices and to a controller, wherein the first communication subsystem is configured to request the block of data. The example apparatus can further include a second communication subsystem within the apparatus and coupled to the plurality of computing devices and to the controller. The second communication subsystem can be configured to transfer the block of data from the first controller to at least one of the plurality of computing devices.

### TECHNICAL FIELD

The present disclosure relates generally to semiconductor memory and methods, and more particularly, to apparatuses, systems, and methods for an extended memory interface.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 is a functional block diagram in the form of a computing system including an apparatus including a storage controller and a number of memory devices in accordance with a number of embodiments of the present disclosure.

FIG. 2 is yet another functional block diagram in the form of an apparatus including a storage controller in accordance with a number of embodiments of the present disclosure.

FIG. 3 is yet another functional block diagram in the form of an apparatus including a storage controller in accordance with a number of embodiments of the present disclosure.

FIG. 4 is yet another functional block diagram in the form of an apparatus including a storage controller in accordance with a number of embodiments of the present disclosure.

FIG. 5 is a block diagram in the form of a computing tile in accordance with a number of embodiments of the present disclosure.

FIG. 6 is another block diagram in the form of a computing tile in accordance with a number of embodiments of the present disclosure.

FIG. 7 is a flow diagram representing an example method for an extended memory interface in accordance with a number of embodiments of the present disclosure.

### DETAILED DESCRIPTION

Systems, apparatuses, and methods related to extended memory interfaces are described. An apparatus related to extended memory interfaces can include a plurality of computing devices coupled to one another. Each of the plurality of computing devices can include a processing unit configured to perform an operation on a block of data in response to receipt of the block of data. Each of the plurality of computing devices can further include a memory array configured as a cache for the processing unit. The example apparatus can further include a first interface coupled to the plurality of computing devices and to a controller, wherein the first interface is configured to request the block of data. The example apparatus can further include a second interface coupled to the plurality of computing devices and to the controller. The second interface can be configured to transfer the block of data from the first controller to at least one of the plurality of computing devices.

An extended memory interface can transfer instructions to perform operations specified by a single address and operand and may be performed by the computing device that includes the processing unit and the memory resource. The computing device can perform extended memory operations on data streamed through the computing tile without receipt of intervening commands. In an example, a computing device is configured to receive a command to perform an operation that comprises performing an operation on data with the processing unit of the computing device and determine that an operand corresponding to the operation is stored in the memory resource. The computing device can further perform the operation using the operand stored in the memory resource.

As used herein, an “extended memory operation” refers to a memory operation that can be specified by a single address (e.g., a memory address) and an operand, such as a 64-bit operand. An operand can be represented as a plurality of bits (e.g., a bit string or string of bits). Embodiments are not limited to operations specified by a 64-bit operand, however, and the operation can be specified by an operand that is larger (e.g., 128-bits, etc.) or smaller (e.g., 32-bits) than 64-bits. As described herein, the effective address space accessible with which to perform extended memory operations is the size of a memory device or file system accessible to a host computing system or storage controller.

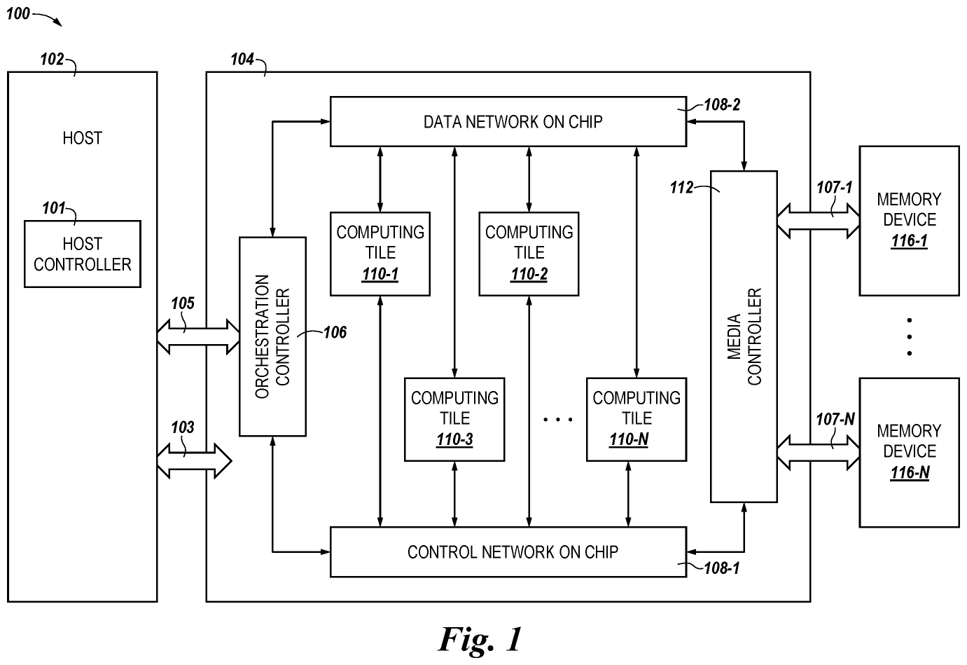

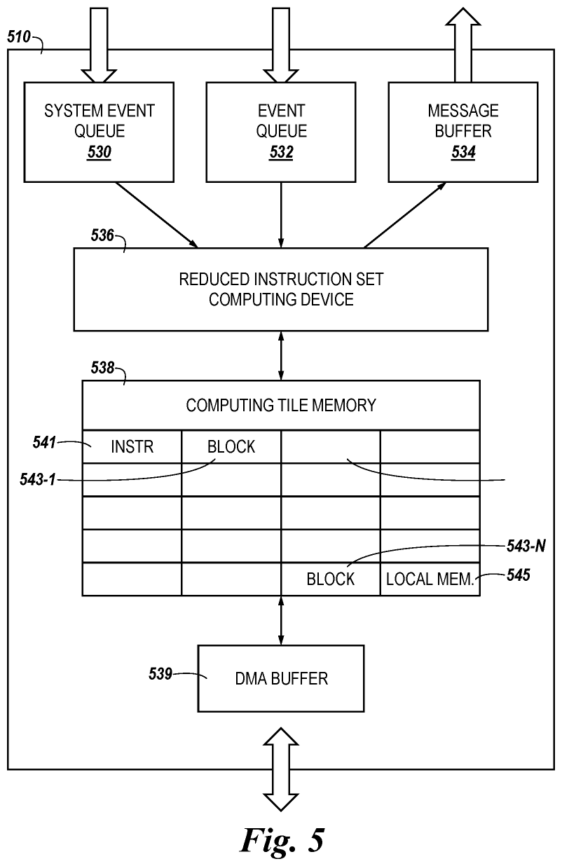

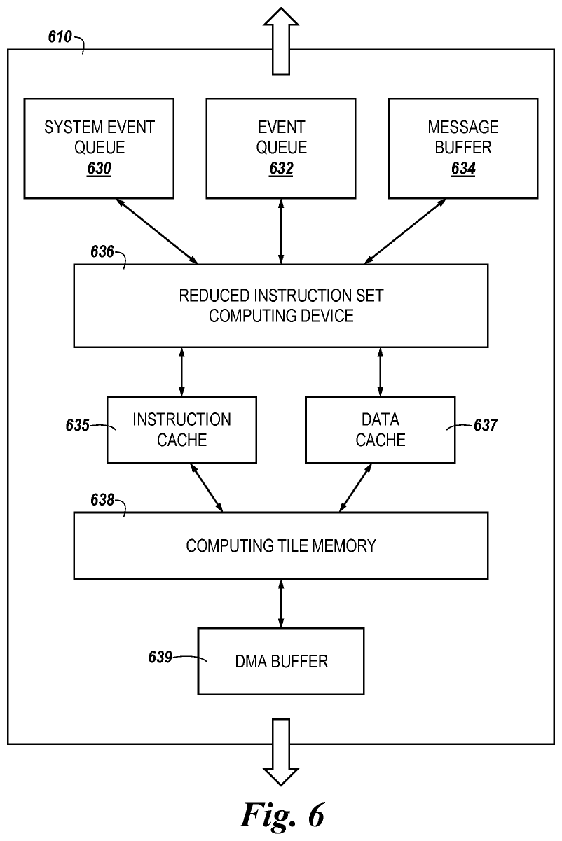

Extended memory operations can include instructions and/or operations that can be performed by a processing device (e.g., by a processing device such as the reduced instruction set computing device 536, 636 illustrated in FIGS. 5 and 6, herein) of a computing tile (e.g., the computing tile(s) 110, 210, 310, 410, 510, 610 illustrated in FIGS. 1-6, herein). In some embodiments, performing an extended memory operation can include retrieving data and/or instructions stored in a memory resource (e.g., the computing tile memory 538, 638 illustrated in FIGS. 5 and 6, herein), performing the operation within the computing tile (e.g., without transferring the data or instructions to circuitry external to the computing tile), and storing the result of the extended memory operation in the memory resource of the computing tile or in secondary storage (e.g., in a memory device such as the memory device 116 illustrated in FIG. 1, herein).

Non-limiting examples of extended memory operations can include floating point add accumulate, 32-bit complex operations, square root address (SQRT(addr)) operations, conversion operations (e.g., converting between floating-point and integer formats, and/or converting between floating-point and posit formats), normalizing data to a fixed format, absolute value operations, etc. In some embodiments, extended memory operations can include operations performed by the computing tile that update in place (e.g., in which a result of an extended memory operation is stored at the address in which an operand used in performance of the extended memory operation is stored prior to performance of the extended memory operation), as well as operations in which previously stored data is used to determine a new data (e.g., operations in which an operand stored at a particular address is used to generate new data that overwrites the particular address where the operand was stored).

As a result, in some embodiments, performance of extended memory operations can mitigate or eliminate locking or mutex operations, because the extended memory operation(s) can be performed within the computing tile, which can reduce contention between multiple thread execution. Reducing or eliminating performance of locking or mutex operations on threads during performance of the extended memory operations can lead to increased performance of a computing system, for example, because extended memory operations can be performed in parallel within a same computing tile or across two or more of the computing tiles that are in communication with each other. In addition, in some embodiments, extended memory operations described herein can mitigate or eliminate locking or mutex operations when a result of the extended memory operation is transferred from the computing tile that performed the operation to a host.

Memory devices may be used to store important or critical data in a computing device and can transfer, via at least one extended memory interface, such data between a host associated with the computing device. However, as the size and quantity of data stored by memory devices increases, transferring the data to and from the host can become time consuming and resource intensive. For example, when a host requests performance of memory operations using large blocks of data, an amount of time and/or an amount of resources consumed in obliging the request can increase in proportion to the size and/or quantity of data associated with the blocks of data.

As storage capability of memory devices increases, these effects can become more pronounced as more and more data are able to be stored by the memory device and are therefore available for use in memory operations. In addition, because data may be processed (e.g., memory operations may be performed on the data), as the amount of data that is able to be stored in memory devices increases, the amount of data that may be processed can also increase. This can lead to increased processing time and/or increased processing resource consumption, which can be compounded in performance of certain types of memory operations. In order to alleviate these and other issues, embodiments herein can allow for extended memory operations to be performed using a memory device, one or more computing tiles, and/or memory array(s).

In some approaches, performing memory operations can require multiple clock cycles and/or multiple function calls to memory of a computing system such as a memory device and/or memory array. In contrast, embodiments herein can allow for performance of extended memory operations in which a memory operation is performed with a single function call or command. For example, in contrast to approaches in which at least one command and/or function call is utilized to load data to be operated upon and then at least one subsequent function call or command to store the data that has been operated upon is utilized, embodiments herein can allow for performance of memory operations using fewer function calls or commands in comparison to other approaches. Further, the computing devices of the computing system can receive requests to perform the memory operations via a first interface (e.g., a control network-on-chip (NOC), communication sub-system, etc.) and can receive blocks of data for executing the requested memory operations from the memory device via a second interface.

By reducing the number of function calls and/or commands utilized in performance of memory operations, an amount of time consumed in performing such operations and/or an amount of computing resources consumed in performance of such operations can be reduced in comparison to approaches in which multiple function calls and/or commands are required for performance of memory operations. Further, embodiments herein can reduce movement of data within a memory device and/or memory array because data may not need to be loaded into a specific location prior to performance of memory operations. This can reduce processing time in comparison to some approaches, especially in scenarios in which a large amount of data is subject to a memory operation.

Further, extended memory operations described herein can allow for a much larger set of type fields in comparison to some approaches. For example, an instruction executed by a host to request performance of an operation using data in a memory device (e.g., a memory sub-system) can include a type, an address, and a data field. The instruction can be sent to at least one of a plurality of computing devices via a first interface (e.g., a control network-on-chip (NOC)) and the data can be transferred from the memory device via a second interface (e.g., a data network-on-chip (NOC)). The type field can correspond to the particular operation being requested, the address can correspond to an address in which data to be used in performance of the operation is stored, and the data field can correspond to the data (e.g., an operand) to be used in performing the operation. In some approaches, type fields can be limited to different size reads and/or writes, as well as some simple integer accumulate operations. In contrast, embodiments herein can allow for a broader spectrum of type fields to be utilized because the effective address space that can be used when performing extended memory operations can correspond to a size of the memory device. By extending the address space available to perform operations, embodiments herein can therefore allow for a broader range of type fields and, therefore, a broader spectrum of memory operations can be performed than in approaches that do not allow for an effective address space that is the seize of the memory device.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

As used herein, designators such as “X,” “Y,” “N,” “M,” “A,” “B,” “C,” “D,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more memory banks, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

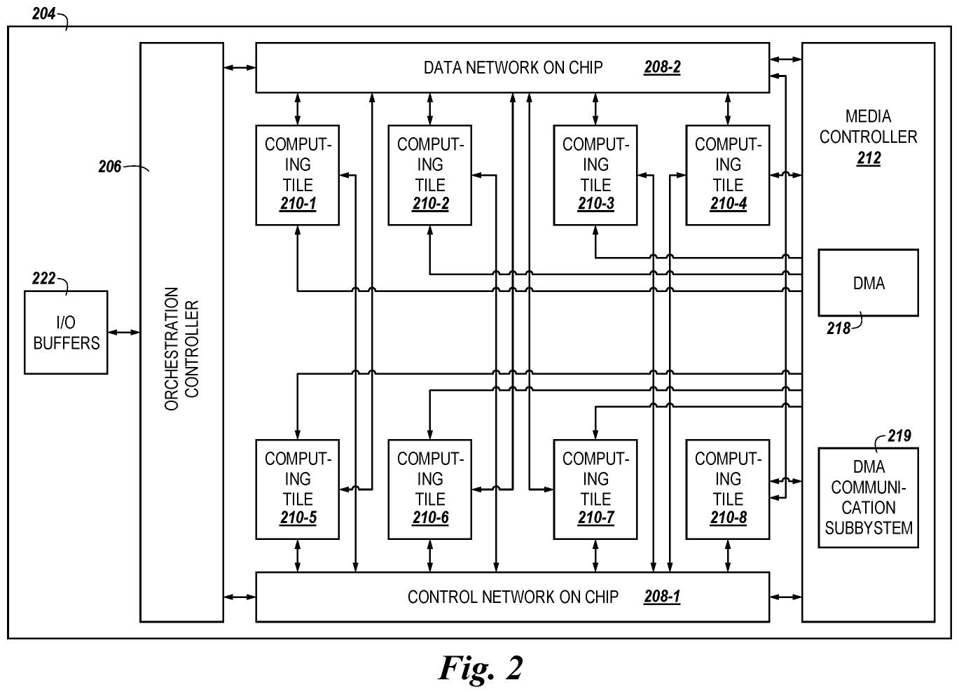

The figures herein follow a numbering convention in which the first digit or digits correspond to the figure number and the remaining digits identify an element or component in the figure. Similar elements or components between different figures may be identified by the use of similar digits. For example, 104 may reference element “04” in FIG. 1, and a similar element may be referenced as 204 in FIG. 2. A group or plurality of similar elements or components may generally be referred to herein with a single element number. For example, a plurality of reference elements 110-1, 110-2, . . . , 110-N may be referred to generally as 110. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram in the form of a computing system 100 including an apparatus including a storage controller 104 and a number of memory devices 116-1, . . . , 116-N in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. In the embodiment illustrated in FIG. 1, memory devices 116-1 . . . 116-N can include one or more memory modules (e.g., single in-line memory modules, dual in-line memory modules, etc.). The memory devices 116-1, . . . , 116-N can include volatile memory and/or non-volatile memory. In a number of embodiments, memory devices 116-1, . . . , 116-N can include a multi-chip device. A multi-chip device can include a number of different memory types and/or memory modules. For example, a memory system can include non-volatile or volatile memory on any type of a module.

The memory devices 116-1, . . . , 116-N can provide main memory for the computing system 100 or could be used as additional memory or storage throughout the computing system 100. Each memory device 116-1, . . . , 116-N can include one or more arrays of memory cells, e.g., volatile and/or non-volatile memory cells. The arrays can be flash arrays with a NAND architecture, for example. Embodiments are not limited to a particular type of memory device. For instance, the memory device can include RAM, ROM, DRAM, SDRAM, PCRAM, RRAM, and flash memory, among others.

In embodiments in which the memory devices 116-1, . . . , 116-N include non-volatile memory, the memory devices 116-1, . . . , 116-N can be flash memory devices such as NAND or NOR flash memory devices. Embodiments are not so limited, however, and the memory devices 116-1, . . . , 116-N can include other non-volatile memory devices such as non-volatile random-access memory devices (e.g., NVRAM, ReRAM, FeRAM, MRAM, PCM), “emerging” memory devices such as 3-D Crosspoint (3D XP) memory devices, etc., or combinations thereof. A 3D XP array of non-volatile memory can perform bit storage based on a change of bulk resistance, in conjunction with a stackable cross-gridded data access array. Additionally, in contrast to many flash-based memories, 3D XP non-volatile memory can perform a write in-place operation, where a non-volatile memory cell can be programmed without the non-volatile memory cell being previously erased.

As illustrated in FIG. 1, a host 102 can be coupled to a storage controller 104, which can in turn be coupled to the memory devices 116-1 . . . 116-N. In a number of embodiments, each memory device 116-1 . . . 116-N can be coupled to the storage controller 104 via a channel (e.g., channels 107-1, . . . , 107-N). In FIG. 1, the storage controller 104, which includes an orchestration controller 106, is coupled to the host 102 via channel 103 and the orchestration controller 106 is coupled to the host 102 via a channel 105. The host 102 can be a host system such as a personal laptop computer, a desktop computer, a digital camera, a smart phone, a memory card reader, and/or internet-of-thing enabled device, among various other types of hosts, and can include a memory access device, e.g., a processor (or processing device). One of ordinary skill in the art will appreciate that “a processor” can intend one or more processors, such as a parallel processing system, a number of coprocessors, etc.

The host 102 can include a system motherboard and/or backplane and can include a number of processing resources (e.g., one or more processors, microprocessors, or some other type of controlling circuitry). In some embodiments, the host can include a host controller 101, which can be configured to control at least some operations of the host 102 and/or the storage controller 104 by, for example, generating and transferring commands to the storage controller to cause performance of operations such as extended memory operations. The host controller 101 can include circuitry (e.g., hardware) that can be configured to control at least some operations of the host 102 and/or the storage controller 104. For example, the host controller 101 can be an application specific integrated circuit (ASIC), a field programmable gate array (FPGA), or other combination of circuitry and/or logic configured to control at least some operations of the host 102 and/or the storage controller 104.

The storage controller 104 can include an orchestration controller 106, a control network on a chip (NoC) 108-1, a data NoC 108-2, a plurality of computing tiles 110-1, . . . , 110-N, which are described in more detail in connection with FIGS. 5 and 6, herein, and a media controller 112. The control NoC 108-1 and the data Noc 108-2 can be referred to herein as communication subsystems. The plurality of computing tiles 110 may be referred to herein as “computing devices.” The orchestration controller 106 (or, for simplicity, “controller”) can include circuitry and/or logic configured to allocate and de-allocate resources to the computing tiles 110-1, . . . , 110-N during performance of operations described herein. For example, the orchestration controller 106 can allocate and/or de-allocate resources to the computing tiles 110-1, . . . , 110-N during performance of extended memory operations described herein. In some embodiments, the orchestration controller 106 can be an application specific integrated circuit (ASIC), a field programmable gate array (FPGA), or other combination of circuitry and/or logic configured to orchestrate operations (e.g., extended memory operations) performed by the computing tiles 110-1, . . . , 110-N. For example, the orchestration controller 106 can include circuitry and/or logic to control the computing tiles 110-1, . . . , 110-N to perform operations on blocks of received data to perform extended memory operations on data (e.g., blocks of data).

The system 100 can include separate integrated circuits or the host 102, the storage controller 104, the orchestration controller 106, the control network-on-chip (NoC) 108-1, the data NoC 108-2, and/or the memory devices 116-1, . . . , 116-N can be on the same integrated circuit. The system 100 can be, for instance, a server system and/or a high performance computing (HPC) system and/or a portion thereof. Although the example shown in FIG. 1 illustrate a system having a Von Neumann architecture, embodiments of the present disclosure can be implemented in non-Von Neumann architectures, which may not include one or more components (e.g., CPU, ALU, etc.) often associated with a Von Neumann architecture.

The orchestration controller 106 can be configured to request a block of data from one or more of the memory devices 116-1, . . . , 116-N and cause the computing tiles 110-1, . . . , 110-N to perform an operation (e.g., an extended memory operation) on the block of data. The operation may be performed to evaluate a function that can be specified by a single address and one or more operands associated with the block of data. The orchestration controller 106 can be further configured to cause a result of the extended memory operation to be stored in one or more of the computing tiles 110-1, . . . , 110-N and/or to be transferred to an interface (e.g., communication paths 103 and/or 105) and/or the host 102.

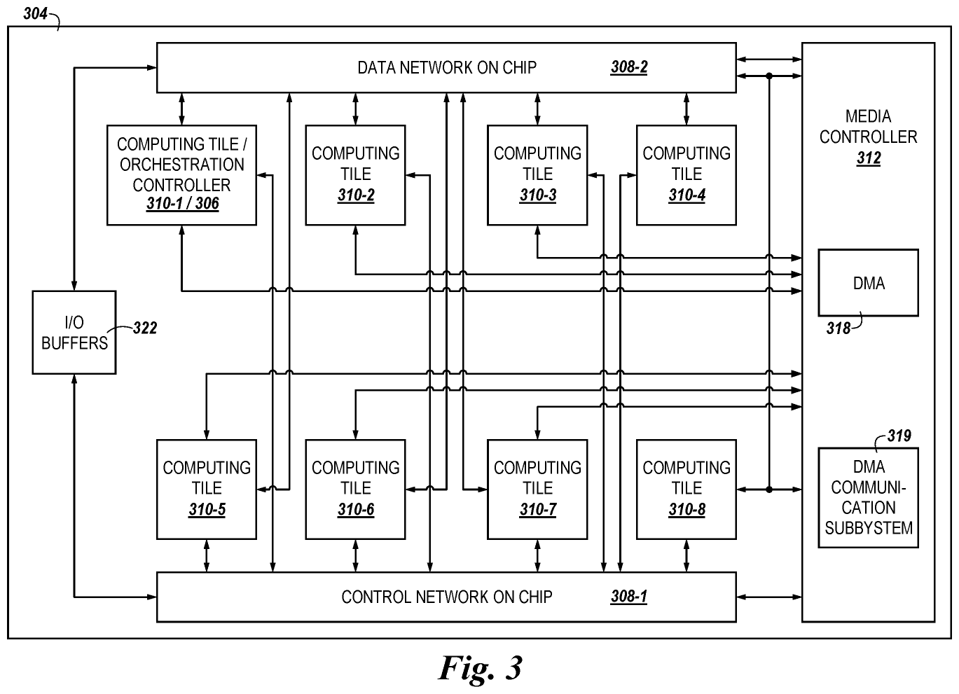

In some embodiments, the orchestration controller 106 can be one of the plurality of computing tiles 110. For example, the orchestration controller 106 can include the same or similar circuitry that the computing tiles 110-1, . . . , 110-N include, as described in more detail in connection with FIG. 3, herein. However, in some embodiments, the orchestration controller 106 can be a distinct or separate component from the computing tiles 110-1, . . . , 110-N, and may therefore include different circuitry than the computing tiles 110, as shown in FIG. 1.

The control NoC 108-1 can be a communication subsystem that allows for communication between the orchestration controller 106 and the computing tiles 110-1, . . . , 110-N. The control NoC 108-1 can include circuitry and/or logic to facilitate the communication between the orchestration controller 106 and the computing tiles 110-1, . . . , 110-N. In some embodiments, the control NoC 108-1 can receive instructions from the orchestration controller 106 to perform an operation on a block of data stored in a memory device 116.

In some embodiments, the control NoC 108-1 can request a remote command, start a DMA command, send a read/write location, and/or send a start function execution command to the orchestration controller 106 and/or one of the plurality of computing devices 110. In some embodiments, the control NoC 108-1 can request that a block of data be copied from a buffer of a computing device 110 to a buffer of a memory controller 112 or memory device 116. Vice versa, the control NoC 108-1 can request that a block of data be copied to the buffer of the computing device 110 from the buffer of the media controller 112 or memory device 116. The control NoC 108-1 can request that a block of data be copied to a computing device 110 from a buffer of the host 102 or, vice versa, request that a block of data be copied from a computing device 110 to a host 102. The control NoC 108-1 can request that a block of data be copied to a buffer of the host 102 from a buffer of the memory controller 112 or memory device 116. Vice versa, the control NoC 108-1 can request that a block of data be copied from a buffer of the host 102 to a buffer of the memory controller 112 or memory device 116. Further, in some embodiments, the control NoC 108-1 can request that a command from a host be executed on a computing tile 110. The control NoC 108-1 can request that a command from a computing tile 110 be executed on an additional computing tile 110. The control NoC 108-1 can request that a command from a media controller 112 be executed on a computing tile 110. In some embodiments, as described in more detail in connection with FIG. 3, herein, the control NoC 108-1 can include at least a portion of the orchestration controller 106. For example, the control NoC 108-1 can include the circuitry that comprises the orchestration controller 106, or a portion thereof.

In some embodiments, the data NoC 108-2 can transfer a block of data (e.g., a direct memory access (DMA) block of data) from a computing tile 110 to a media device 116 (via the media controller 112) or, vice versa, can transfer a block of data to a computing tile 110 from a media device 116. The data NoC 108-2 can transfer a block of data (e.g., a DMA block) from a computing tile 110 to a host 102 or, vice versa, to a computing tile 110 from a host 102. Further, the data NoC 108-2 can transfer a block of data (e.g., a DMA block) from a host 102 to a media device 116 or, vice versa, to a host 102 from a media device 116. In some embodiments, the data NoC 108-2 can receive an output (e.g., data on which an extended memory operation has been performed) from the computing tiles 110-1, . . . , 110-N and transfer the output from the computing tiles 110-1, . . . , 110-N to the orchestration controller 106 and/or the host 102, and vice versa. For example, the NoC 108-2 may be configured to receive data that has been subjected to an extended memory operation by the computing tiles 110-1, . . . , 110-N and transfer the data that corresponds to the result of the extended memory operation to the orchestration controller 106 and/or the host 102. In some embodiments, as described in more detail in connection with FIG. 3, herein, the NoC 108-2 can include at least a portion of the orchestration controller 106. For example, the NoC 108 can include the circuitry that comprises the orchestration controller 106, or a portion thereof.

Although a control NoC 108-1 and a data NoC 108-2 are shown in FIG. 1, embodiments are not limited to utilization of a control NoC 108-1 and data NoC 108-2 to provide a communication path between the orchestration controller 106 and the computing tiles 110-1, . . . , 110-N. For example, other communication paths such as a storage controller crossbar (XBAR) may be used to facilitate communication between the computing tiles 110-1, . . . , 110-N and the orchestration controller 106.

The media controller 112 can be a “standard” or “dumb” media controller. For example, the media controller 112 can be configured to perform simple operations such as copy, write, read, error correct, etc. for the memory devices 116-1, . . . , 116-N. However, in some embodiments, the media controller 112 does not perform processing (e.g., operations to manipulate data) on data associated with the memory devices 116-1, . . . , 116-N. For example, the media controller 112 can cause a read and/or write operation to be performed to read or write data from or to the memory devices 116-1, . . . , 116-N via the communication paths 107-1, . . . , 107-N, but the media controller 112 may not perform processing on the data read from or written to the memory devices 116-1, . . . , 116-N. In some embodiments, the media controller 112 can be a non-volatile media controller, although embodiments are not so limited.

The embodiment of FIG. 1 can include additional circuitry that is not illustrated so as not to obscure embodiments of the present disclosure. For example, the storage controller 104 can include address circuitry to latch address signals provided over I/O connections through I/O circuitry. Address signals can be received and decoded by a row decoder and a column decoder to access the memory devices 116-1, . . . , 116-N. It will be appreciated by those skilled in the art that the number of address input connections can depend on the density and architecture of the memory devices 116-1, . . . , 116-N.

In some embodiments, extended memory operations can be performed using the computing system 100 shown in FIG. 1 by selectively storing or mapping data (e.g., a file) into a computing tile 110. The data can be selectively stored in an address space of the computing tile memory (e.g., in a portion such as the block 543-1 of the computing tile memory 538 illustrated in FIG. 5, herein). In some embodiments, the data can be selectively stored or mapped in the computing tile 110 in response to a command received from the host 102 and/or the orchestration controller 106. In embodiments in which the command is received from the host 102, the command can be transferred to the computing tile 110 via an interface (e.g., communication paths 103 and/or 105) associated with the host 102 and via the control NoC 108-1. The interface(s) 103/105, control NoC 108-1, and data NoC 108-2 can be peripheral component interconnect express (PCIe) buses, double data rate (DDR) interfaces, or other suitable interfaces or buses. Embodiments are not so limited, however, and in embodiments in which the command is received by the computing tile from the orchestration controller 106, the command can be transferred directly from the orchestration controller 106, or via the control NoC 108-1.

In a non-limiting example in which the data (e.g., in which data to be used in performance of an extended memory operation) is mapped into the computing tile 110, the host controller 101 can transfer a command to the computing tile 110 to initiate performance of an extended memory operation using the data mapped into the computing tile 110. In some embodiments, the host controller 101 can look up an address (e.g., a physical address) corresponding to the data mapped into the computing tile 110 and determine, based on the address, which computing tile (e.g., the computing tile 110-1) the address (and hence, the data) is mapped to. The command can then be transferred to the computing tile (e.g., the computing tile 110-1) that contains the address (and hence, the data).

In some embodiments, the data can be a 64-bit operand, although embodiments are not limited to operands having a specific size or length. In an embodiment in which the data is a 64-bit operand, once the host controller 101 transfers the command to initiate performance of the extended memory operation to the correct computing tile (e.g., the computing tile 110-1) based on the address at which the data is stored, the computing tile (e.g., the computing tile 110-1) can perform the extended memory operation using the data.

In some embodiments, the computing tiles 110 can be separately addressable across a contiguous address space, which can facilitate performance of extended memory operations as described herein. That is, an address at which data is stored, or to which data is mapped, can be unique for all the computing tiles 110 such that when the host controller 101 looks up the address, the address corresponds to a location in a particular computing tile (e.g., the computing tile 110-1).

For example, a first computing tile (e.g., the computing tile 110-1) can have a first set of addresses associated therewith, a second computing tile (e.g., the computing tile 110-2) can have a second set of addresses associated therewith, a third computing tile (e.g., the computing tile 110-3) can have a third set of addresses associated therewith, through the n-th computing tile (e.g., the computing tile 110-N), which can have an n-th set of addresses associated therewith. That is, the first computing tile 110-1 can have a set of addresses 0000000 to 0999999, the second computing tile 110-2 can have a set of addresses 1000000 to 1999999, the third computing tile 110-3 can have a set of addresses 2000000 to 2999999, etc. It will be appreciated that these address numbers are merely illustrative, non-limiting, and can be dependent on the architecture and/or size (e.g., storage capacity) of the computing tiles 110.

As a non-limiting example in which the extended memory operation comprises a floating-point-add-accumulate operation (FLOATINGPOINT_ADD_ACCUMULATE), the computing tiles 110 can treat the destination address as a floating-point number, add the floating-point number to the argument stored at the address of the computing tile 110, and store the result back in the original address. For example, when the host controller 101 (or the orchestration controller 106) initiates performance of a floating-point add accumulate extended memory operation, the address of the computing tile 110 that the host looks up (e.g., the address in the computing tile to which the data is mapped) can be treated as a floating-point number and the data stored in the address can be treated as an operand for performance of the extended memory operation. Responsive to receipt of the command to initiate the extended memory operation, the computing tile 110 to which the data (e.g., the operand in this example) is mapped can perform an addition operation to add the data to the address (e.g., the numerical value of the address) and store the result of the addition back in the original address of the computing tile 110.

As described above, performance of such extended memory operations can, in some embodiments require only a single command (e.g., request command) to be transferred from the host 102 (e.g., from the host controller 101) to the memory device 104 or from the orchestration controller 106 to the computing tile(s) 110. In contrast to some previous approaches, this can reduce an amount of time, for example, for multiple commands to traverse the interface(s) 103, 105 and/or for data, such as operands to be moved from one address to another within the computing tile(s) 110, consumed in performance of operations.

In addition, performance of extended memory operations in accordance with the disclosure can further reduce an amount of processing power or processing time since the data mapped into the computing tile 110 in which the extended memory operation is performed can be utilized as an operand for the extended memory operation and/or the address to which the data is mapped can be used as an operand for the extended memory operation, in contrast to approaches in which the operands must be retrieved and loaded from different locations prior to performance of operations. That is, at least because embodiments herein allow for loading of the operand to be skipped, performance of the computing system 100 may be improved in comparison to approaches that load the operands and subsequently store a result of an operations performed between the operands.

Further, in some embodiments, because the extended memory operation can be performed within a computing tile 110 using the address and the data stored in the address and, in some embodiments, because the result of the extended memory operation can be stored back in the original address, locking or mutex operations may be relaxed or not required during performance of the extended memory operation. Reducing or eliminating performance of locking or mutex operations on threads during performance of the extended memory operations can lead to increased performance of the computing system 100 because extended memory operations can be performed in parallel within a same computing tile 110 or across two or more of the computing tiles 110.

In some embodiments, valid mappings of data in the computing tiles 110 can include a base address, a segment size, and/or a length. The base address can correspond to an address in the computing tile 110 in which the data mapping is stored. The segment size can correspond to an amount of data (e.g., in bytes) that the computing system 100 can process, and the length can correspond to a quantity of bits corresponding to the data. It is noted that, in some embodiments, the data stored in the computing tile(s) 110 can be uncacheable on the host 102. For example, the extended memory operations can be performed entirely within the computing tiles 110 without encumbering or otherwise transferring the data to or from the host 102 during performance of the extended memory operations.

In a non-limiting example in which the base address is 4096, the segment size is 1024, and the length is 16,386, a mapped address, 7234, may be in a third segment, which can correspond to a third computing tile (e.g., the computing tile 110-3) among the plurality of computing tiles 110. In this example, the host 102, the orchestration controller 106, and/or the control NoC 108-1 and data NoC 108-2 can forward a command (e.g., a request) to perform an extended memory operation to the third computing tile 110-3. The third computing tile 110-3 can determine if data is stored in the mapped address in a memory (e.g., a computing tile memory 538, 638 illustrated in FIGS. 5 and 6, herein) of the third computing tile 110-3. If data is stored in the mapped address (e.g., the address in the third computing tile 110-3), the third computing tile 110-3 can perform a requested extended memory operation using that data and can store a result of the extended memory operation back into the address in which the data was originally stored.

In some embodiments, the computing tile 110 that contains the data that is requested for performance of an extended memory operation can be determined by the host controller 101, the orchestration controller 106, and/or the control NoC 108-1 and data NoC 108-2. For example, a portion of a total address space available to all the computing tiles 110 can be allocated to each respective computing tile. Accordingly, the host controller 101, the orchestration controller 106, and/or the control NoC 108-1 and data NoC 108-2 can be provided with information corresponding to which portions of the total address space correspond to which computing tiles 110 and can therefore direct the relevant computing tiles 110 to perform extended memory operations. In some embodiments, the host controller 101, the orchestration controller 106, and/or the control NoC 108-1 and data NoC 108-2 can store addresses (or address ranges) that correspond to the respective computing tiles 110 in a data structure, such as a table, and direct performance of the extended memory operations to the computing tiles 110 based on the addresses stored in the data structure.

Embodiments are not so limited, however, and in some embodiments, the host controller 101, the orchestration controller 106, and/or the NoC 108 can determine a size (e.g., an amount of data) of the memory resource(s) (e.g., each computing tile memory 538, 638 illustrated in FIGS. 5 and 6, herein) and, based on the size of the memory resource(s) associated with each computing tile 110 and the total address space available to all the computing tiles 110, determine which computing tile 110 stores data to be used in performance of an extended memory operation. In embodiments in which the host controller 101, the orchestration controller 106, and/or the control NoC 108-1 and data NoC 108-2 determine the computing tile 110 that stores the data to be used in performance of an extended memory operation based on the total address space available to all the computing tiles 110 and the amount of memory resource(s) available to each computing tile 110, it can be possible to perform extended memory operations across multiple non-overlapping portions of the computing tile memory resource(s).

Continuing with the above example, if there is not data in the requested address, the third computing tile 110-3 can request the data as described in more detail in connection with FIGS. 2-6, herein, and perform the extended memory operation once the data is loaded into the address of the third computing tile 110-3. In some embodiments, once the extended memory operation is completed by the computing tile (e.g., the third computing tile 110-3 in this example), the orchestration controller 106 and/or the host 102 can be notified and/or a result of the extended memory operation can be transferred to the orchestration controller 106 and/or the host 102.

In some embodiments, the media controller 112 can be configured to retrieve blocks of data from a memory device(s) 116-1, . . . , 116-N coupled to the storage controller 104 in response to a request from the orchestration controller 106 or a host 102. The media controller can subsequently cause the blocks of data to be transferred to the computing tiles 110-1, . . . , 110-N and/or the orchestration controller 106.

Similarly, the media controller 112 can be configured to receive blocks of data from the computing tiles 110 and/or the orchestration controller 106. The media controller 112 can subsequently cause the blocks of data to be transferred to a memory device 116 coupled to the storage controller 104.

The blocks of data can be approximately 4 kilobytes in size (although embodiments are not limited to this particular size) and can be processed in a streaming manner by the computing tiles 110-1, . . . , 110-N in response to one or more commands generated by the orchestration controller 106 and/or a host and sent via the control NoC 108-1. In some embodiments, the blocks of data can be 32-bit, 64-bit, 128-bit, etc. words or chunks of data, and/or the blocks of data can correspond to operands to be used in performance of an extended memory operation.

For example, as described in more detail in connection with FIGS. 5 and 6, herein, because the computing tiles 110 can perform an extended memory operation (e.g., process) a second block of data in response to completion of performance of an extended memory operation on a preceding block of data, the blocks of data can be continuously streamed through the computing tiles 110 while the blocks of data are being processed by the computing tiles 110. In some embodiments, the blocks of data can be processed in a streaming fashion through the computing tiles 110 in the absence of an intervening command from the orchestration controller 106 and/or the host 102. That is, in some embodiments, the orchestration controller 106 (or host) can issue a command to cause the computing tiles 110 to process blocks of data received thereto and blocks of data that are subsequently received by the computing tiles 110 can be processed in the absence of an additional command from the orchestration controller 106.

In some embodiments, processing the blocks of data can include performing an extended memory operation using the blocks of data. For example, the computing tiles 110-1, . . . , 110-N can, in response to commands from the orchestration controller 106 via the control NoC 108-1, perform extended memory operations the blocks of data to evaluate one or more functions, remove unwanted data, extract relevant data, or otherwise use the blocks of data in connection with performance of an extended memory operation.

In a non-limiting example in which the data (e.g., in which data to be used in performance of an extended memory operation) is mapped into one or more of the computing tiles 110, the orchestration controller 106 can transfer a command to the computing tile 106 to initiate performance of an extended memory operation using the data mapped into the computing tile(s) 110. In some embodiments, the orchestration controller 106 can look up an address (e.g., a physical address) corresponding to the data mapped into the computing tile(s) 110 and determine, based on the address, which computing tile (e.g., the computing tile 110-1) the address (and hence, the data) is mapped to. The command can then be transferred to the computing tile (e.g., the computing tile 110-1) that contains the address (and hence, the data). In some embodiments, the command can be transferred to the computing tile (e.g., the computing tile 110-1) via the control NoC 208-1.

The orchestration controller 106 (or a host) can be further configured to send commands to the computing tiles 110 to allocate and/or de-allocate resources available to the computing tiles 110 for use in performing extended memory operations using the blocks of data. In some embodiments, allocating and/or de-allocating resources available to the computing tiles 110 can include selectively enabling some of the computing tiles 110 while selectively disabling some of the computing tiles 110. For example, if less than a total number of computing tiles 110 are required to process the blocks of data, the orchestration controller 106 can send a command to the computing tiles 110 that are to be used for processing the blocks of data to enable only those computing tiles 110 desired to process the blocks of data.

The orchestration controller 106 can, in some embodiments, be further configured to send commands to synchronize performance of operations, such as extended memory operations, performed by the computing tiles 110. For example, the orchestration controller 106 (and/or a host) can send a command to a first computing tile 110-1 to cause the first computing tile 110-1 to perform a first extended memory operation, and the orchestration controller 106 (or the host) can send a command to a second computing tile 110-2 to perform a second extended memory operation using the second computing tile. Synchronization of performance of operations, such as extended memory operations, performed by the computing tiles 110 by the orchestration controller 106 can further include causing the computing tiles 110 to perform particular operations at particular time or in a particular order.

As described above, data that results from performance of an extended memory operation can be stored in the original address in the computing tile 110 in which the data was stored prior to performance of the extended memory operation, however, in some embodiments, blocks of data that result from performance of the extended memory operation can be converted into logical records subsequent to performance of the extended memory operation. The logical records can comprise data records that are independent of their physical locations. For example, the logical records may be data records that point to an address (e.g., a location) in at least one of the computing tiles 110 where physical data corresponding to performance of the extended memory operation is stored.

As described in more detail in connection with FIGS. 5 and 6, herein, the result of the extended memory operation can be stored in an address of a computing tile memory (e.g., the computing tile memory 538 illustrated in FIG. 5 or the computing tile memory 638 illustrated in FIG. 6) that is the same as the address in which the data is stored prior to performance of the extended memory operation. Embodiments are not so limited, however, and the result of the extended memory operation can be stored in an address of the computing tile memory that is the same as the address in which the data is stored prior to performance of the extended memory operation. In some embodiments, the logical records can point to these address locations such that the result(s) of the extended memory operation can be accessed from the computing tiles 110 and transferred to circuitry external to the computing tiles 110 (e.g., to a host).

In some embodiments, the orchestration controller 106 can receive and/or send blocks of data directly to and from the media controller 112. This can allow the orchestration controller 106 to transfer blocks of data that are not processed (e.g., blocks of data that are not used in performance of extended memory operations) by the computing tiles 110 to and from the media controller 112.

For example, if the orchestration controller 106 receives unprocessed blocks of data from a host 102 coupled to the storage controller 104 that are to be stored by memory device(s) 116 coupled to the storage controller 104, the orchestration controller 106 can cause the unprocessed blocks of data to be transferred to the media controller 112, which can, in turn, cause the unprocessed blocks of data to be transferred to memory device(s) coupled to the storage controller 104.

Similarly, if the host requests an unprocessed (e.g., a full) block of data (e.g., a block of data that is not processed by the computing tiles 110), the media controller 112 can cause unprocessed blocks of data to be transferred to the orchestration controller 106, which can subsequently transfer the unprocessed blocks of data to the host.

FIGS. 2-4 illustrate various examples of a functional block diagram in the form of an apparatus including a storage controller 204, 304, 404 in accordance with a number of embodiments of the present disclosure. In FIGS. 2-4, a media controller 212, 312, 412 is in communication with a plurality of computing tiles 210, 310, 410, a control NoC 208-1, 308-1, 408-1, and an orchestration controller 206, 306, 406, which is in communication with input/output (I/O) buffers 222, 322, 422. Although eight (8) discrete computing tiles 210, 310, 410 are shown in FIGS. 2-4, it will be appreciated that embodiments are not limited to a storage controller 404 that includes eight discrete computing tiles 210, 310, 410. For example, the storage controller 204, 304, 404 can include one or more computing tiles 210, 310, 410, depending on characteristics of the storage controller 204, 304, 404 and/or overall system in which the storage controller 204, 304, 404 is deployed.

As shown in FIGS. 2-4, the media controller 212, 312, 412 can include a direct memory access (DMA) component 218, 318, 418 and a DMA communication subsystem 219, 319, 419. The DMA 218, 318, 418 can facilitate communication between the media controller 218, 318, 418 and memory device(s), such as the memory devices 116-1, . . . , 116-N illustrated in FIG. 1, coupled to the storage controller 204, 304, 404 independent of a central processing unit of a host, such as the host 102 illustrated in FIG. 1. The DMA communication subsystem 219, 319, 419 can be a communication subsystem such as a crossbar (“XBAR”), a network on a chip, or other communication subsystem that allows for interconnection and interoperability between the media controller 212, 312, 412, the storage device(s) coupled to the storage controller 204, 304, 404, and/or the computing tiles 210, 310, 410.

In some embodiments, the control NoC 208-1, 308-1, 408-2 and the data Noc 208-2, 308-2, 408-2 can facilitate visibility between respective address spaces of the computing tiles 210, 310, 410. For example, each computing tile 210, 310, 410, can, responsive to receipt of data and/or a file, store the data in a memory resource (e.g., in the computing tile memory 548 or the computing tile memory 638 illustrated in FIGS. 5 and 6, herein) of the computing tile 210, 310, 410. The computing tiles 210, 310, 410 can associate an address (e.g., a physical address) corresponding to a location in the computing tile 210, 310, 410 memory resource in which the data is stored. In addition, the computing tile 210, 310, 410 can parse (e.g., break) the address associated with the data into logical blocks.

In some embodiments, the zeroth logical block associated with the data can be transferred to a processing device (e.g., the reduced instruction set computing (RISC) device 536 or the RISC device 636 illustrated in FIGS. 5 and 6, herein). A particular computing tile (e.g., computing tile 210-2, 310-2, 410-2) can be configured to recognize that a particular set of logical addresses are accessible to that computing tile 210-2, 310-2, 410-2, while other computing tiles (e.g., computing tile 210-3, 210-4, 310-3, 310-4, 410-3, 410-4, respectively, etc.) can be configured to recognize that different sets of logical addresses are accessible to those computing tiles 210, 310, 410. Stated alternatively, a first computing tile (e.g., the computing tile 210-2, 310-2, 410-2) can have access to a first set of logical addresses associated with that computing tile 210-2, 310-2, 410-2, and a second computing tile (e.g., the computing tile 210-3, 310-3, 410-3) can have access to a second set of logical address associated therewith, etc.

If data corresponding to the second set of logical addresses (e.g., the logical addresses accessible by the second computing tile 210-3, 310-3, 410-3) is requested at the first computing tile (e.g., the computing tile 210-2, 310-2, 410-2), the control NoC 208-1, 308-1, 408-1 can facilitate communication between the first computing tile (e.g., the computing tile 210-2, 310-2, 410-2) and the second computing tile (e.g., the computing tile 210-3, 310-3, 410-3) to allow the first computing tile (e.g., the computing tile 210-2, 310-2, 410-2) to access the data corresponding to the second set of logical addresses (e.g., the set of logical addresses accessible by the second computing tile 210-3, 310-3, 410-3). That is, the control NoC 208-1, 308-1, 408-1 and the data NoC 208-2, 308-2, 408-2 can each facilitate communication between the computing tiles 210, 310, 410 to allow address spaces of the computing tiles 210, 310, 410 to be visible to one another.

In some embodiments, communication between the computing tiles 210, 310, 410 to facilitate address visibility can include receiving, by an event queue (e.g., the event queue 532 and 632 illustrated in FIGS. 5 and 6) of the first computing tile (e.g., the computing tile 210-1, 310-1, 410-1), a message requesting access to the data corresponding to the second set of logical addresses, loading the requested data into a memory resource (e.g., the computing tile memory 538 and 638 illustrated in FIGS. 5 and 6, herein) of the first computing tile, and transferring the requested data to a message buffer (e.g., the message buffer 534 and 634 illustrated in FIGS. 5 and 6, herein). Once the data has been buffered by the message buffer, the data can be transferred to the second computing tile (e.g., the computing tile 210-2, 310-2, 410-2) via the data NoC 208-2, 308-2, 408-2.

For example, during performance of an extended memory operation, the orchestration controller 206, 306, 406 and/or a first computing tile (e.g., the computing tile 210-1, 310-1, 410-1) can determine that the address specified by a host command (e.g., a command to initiate performance of an extended memory operation generated by a host such as the host 102 illustrated in FIG. 1) corresponds to a location in a memory resource of a second computing tile (e.g., the computing tile 210-2, 310-2, 410-2) among the plurality of computing tiles 210, 310, 410. In this case, a computing tile command can be generated and sent from the orchestration controller 206, 306, 406 and/or the first computing tile 210-1, 310-1, 410-1 to the second computing tile 210-2, 310-2, 410-2 to initiate performance of the extended memory operation using an operand stored in the memory resource of the second computing tile 210-2, 310-2, 410-2 at the address specified by the computing tile command.

In response to receipt of the computing tile command, the second computing tile 210-2, 310-2, 410-2 can perform the extended memory operation using the operand stored in the memory resource of the second computing tile 210-2, 310-2, 410-2 at the address specified by the computing tile command. This can reduce command traffic from between the host and the storage controller and/or the computing tiles 210, 310, 410, because the host need not generate additional commands to cause performance of the extended memory operation, which can increase overall performance of a computing system by, for example reducing a time associated with transfer of commands to and from the host.

In some embodiments, the orchestration controller 206, 306, 406 can determine that performing the extended memory operation can include performing multiple sub-operations. For example, an extended memory operation may be parsed or broken into two or more sub-operations that can be performed as part of performing the overall extended memory operation. In this case, the orchestration controller 206, 306, 406 and/or the control NoC 208-1, 308-1, 408-1 and/or the data NoC 208-2, 308-2, 408-2 can utilize the above described address visibility to facilitate performance of the sub-operations by various computing tiles 210, 310, 410. In response to completion of the sub-operation, the orchestration controller 206, 306, 406 can cause the results of the sub-operations to be coalesced into a single result that corresponds to a result of the extended memory operation.

In other embodiments, an application requesting data that is stored in the computing tiles 210, 310, 410 can know (e.g., can be provided with information corresponding to) which computing tiles 210, 310, 410 include the data requested. In this example, the application can request the data from the relevant computing tile 210, 310, 410 and/or the address may be loaded into multiple computing tiles 210, 310, 410 and accessed by the application requesting the data via the data NoC 208-2, 308-2, 408-2.

As shown in FIG. 2, the orchestration controller 206 comprises discrete circuitry that is physically separate from the control NoC 208-1 and the data NoC 208-2. The control and data NoCs 208-1, 208-2 can each be a communication subsystem that is provided as one or more integrated circuits that allows communication between the computing tiles 210, the media controller 212, and/or the orchestration controller 206. Non-limiting examples of a control NoC 208-1 and/or a data NoC 208-2 can include a XBAR or other communications subsystem that allows for interconnection and/or interoperability of the orchestration controller 206, the computing tiles 210, and/or the media controller 212.

As described above, responsive to receipt of a command generated by the orchestration controller 206, the control NoC 208-1, the data NoC 208-2, and/or a host (e.g., the host 102 illustrated in FIG. 1) performance of extended memory operations using data stored in the computing tiles 210 and/or from blocks of data streamed through the computing tiles 210 can be realized.

As shown in FIG. 3, the orchestration controller 306 is resident on one of the computing tiles 310-1 among the plurality of computing tiles 310-1, . . . , 310-8. As used herein, the term “resident on” refers to something that is physically located on a particular component. For example, the orchestration controller 306 being “resident on” one of the computing tiles 310 refers to a condition in which the orchestration controller 306 is physically coupled to a particular computing tile. The term “resident on” may be used interchangeably with other terms such as “deployed on” or “located on,” herein.

As described above, responsive to receipt of a command generated by the computing tile 310-1/orchestration controller 306, the control NoC 308-1, the data NoC 308-2 and/or a host, performance of extended memory operations using data stored in the computing tiles 310 and/or from blocks of data streamed through the computing tiles 310 can be realized.

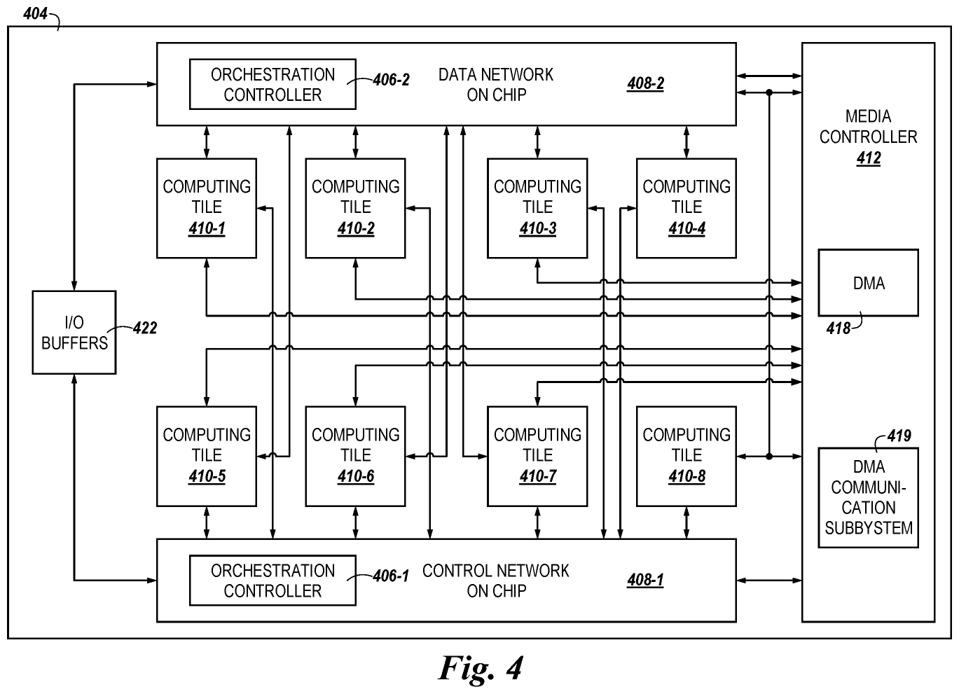

As shown in FIG. 4, the orchestration controller 406 is resident on both the control NoC 408-1 and the data NoC 408-2. In some embodiments, providing the orchestration controller 406 as part of both the control NoC 408-1 and/or the data NoC 408-2 results in a tight coupling of the orchestration controller 406 and the control and data NoCs 408-1, 408-2, respectively, which can result in reduced time consumption to perform extended memory operations using the orchestration controller 406. While illustrated as having the orchestration controller 406-1/406-2 on each of the control NoC 408-1 and the data NoC 408-2, embodiments are not so limited. As an example, the orchestration controller 406-1 may only be on the control NoC 408-1 and not on the data NoC 408-2. Vice versa, the orchestration controller 406-2 may only be on the data NoC 408-2 and not on the control NoC 408-1. Further, there may be an orchestration controller 406-1 on the control NoC 408-1 as well as an orchestration controller 406-2 on the data NoC 408-2.

As described above, responsive to receipt of a command generated by the orchestration controller 406, the control NoC 408-1, the data NoC 408-2, and/or a host, performance of extended memory operations using data stored in the computing tiles 410 and/or from blocks of data streamed through the computing tiles 410 can be realized.

FIG. 5 is a block diagram in the form of a computing tile 510 in accordance with a number of embodiments of the present disclosure. As shown in FIG. 5, the computing tile 510 can include queueing circuitry, which can include a system event queue 530 and/or an event queue 532, and a message buffer 534 (e.g., outbound buffering circuitry). The computing tile 510 can further include a processing device (e.g., a processing unit) such as a reduced instruction set computing (RISC) device 536, a computing tile memory 538 portion, and a direct memory access buffer 539 (e.g., inbound buffering circuitry). The RISC device 536 can be a processing resource that can employ a reduced instruction set architecture (ISA) such as a RISC-V ISA, however, embodiments are not limited to RISC-V ISAs and other processing devices and/or ISAs can be used. The RISC device 536 may be referred to for simplicity as a “processing unit.” In some embodiments, the computing tile 510 shown in FIG. 5 can function as an orchestration controller (e.g., the orchestration controller 106, 206, 306, 406 illustrated in FIGS. 1-4, herein).

The system event queue 530, the event queue 532, and the message buffer 534 can be in communication with an orchestration controller such as the orchestration controller 106, 206, 306, and 406 illustrated in FIGS. 1-4, respectively. In some embodiments, the system event queue 530, the event queue 532, and the message buffer 534 can be in direct communication with the orchestration controller, or the system event queue 530, the event queue 532, and the message buffer 534 can be in communication with a network on a chip such as the control NoC 108-1, 208-1, 308-1, 408-1 and/or the data NoC 108-2, 208-2, 308-2, 408-2 illustrated in FIGS. 1-4, respectively, which can further be in communication with the orchestration controller and/or a host, such as the host 102 illustrated in FIG. 1.

The system event queue 530, the event queue 532, and the message buffer 534 can receive messages and/or commands from the orchestration controller and/or the host, and/or can send messages and/or commands to the orchestration controller and/or the host, via a control NoC and/or a data NoC, to control operation of the computing tile 510 to perform extended memory operations on data that are stored by the computing tile 510. In some embodiments, the commands and/or messages can include messages and/or commands to allocate or de-allocate resources available to the computing tile 510 during performance of the extended memory operations. In addition, the commands and/or messages can include commands and/or messages to synchronize operation of the computing tile 510 with other computing tiles deployed in a storage controller (e.g., the storage controller 104, 204, 304, and 404 illustrated in FIG. 1-4, respectively).

For example, the system event queue 530, the event queue 532, and the message buffer 534 can facilitate communication between the computing tile 510, the orchestration controller, and/or the host to cause the computing tile 510 to perform extended memory operations using data stored in the computing tile memory 538. In a non-limiting example, the system event queue 530, the event queue 532, and the message buffer 534 can process commands and/or messages received from the orchestration controller and/or the host to cause the computing tile 510 to perform an extended memory operation on the stored data and/or an address corresponding to a physical address within the computing tile memory 538 in which the data is stored. This can allow for an extended memory operation to be performed using the data stored in the computing tile memory 538 prior to the data being transferred to circuitry external to the computing tile 510 such as the orchestration controller, a control NoC, a data NoC, or a host (e.g., the host 102 illustrated in FIG. 1, herein).

The system event queue 530 can receive interrupt messages from the orchestration controller or control NoC. The interrupt messages can be processed by the system event queue 532 to cause a command or message sent from the orchestration controller, the host, or the control NoC to be immediately executed. For example, the interrupt message(s) can instruct the system event queue 532 to cause the computing tile 510 to abort operation of pending commands or messages and instead execute a new command or message received from the orchestration controller, the host, or the control NoC. In some embodiments, the new command or message can involve a command or message to initiate an extended memory operation using data stored in the computing tile memory 538.

The event queue 532 can receive messages that can be processed serially. For example, the event queue 532 can receive messages and/or commands from the orchestration controller, the host, or the control NoC and can process the messages received in a serial manner such that the messages are processed in the order in which they are received. Non-limiting examples of messages that can be received and processed by the event queue can include request messages from the orchestration controller and/or the control NoC to initiate processing of a block of data (e.g., a remote procedure call on the computing tile 510), request messages from other computing tiles to provide or alter the contents of a particular memory location in the computing tile memory 538 of the computing tile that receives the message request (e.g., messages to initiate remote read or write operations amongst the computing tiles), synchronization message requests from other computing tiles to synchronize performance of extended memory operations using data stored in the computing tiles, etc.

The message buffer 534 can comprise a buffer region to buffer data to be transferred out of the computing tile 510 to circuitry external to the computing tile 510 such as the orchestration controller, the data NoC, and/or the host. In some embodiments, the message buffer 534 can operate in a serial fashion such that data (e.g., a result of an extended memory operation) is transferred from the buffer out of the computing tile 510 in the order in which it is received by the message buffer 534. The message buffer 534 can further provide routing control and/or bottleneck control by controlling a rate at which the data is transferred out of the message buffer 534. For example, the message buffer 534 can be configured to transfer data out of the computing tile 510 at a rate that allows the data to be transferred out of the computing tile 510 without creating data bottlenecks or routing issues for the orchestration controller, the data NoC, and/or the host.

The RISC device 536 can be in communication with the system event queue 530, the event queue 532, and the message buffer 534 and can handle the commands and/or messages received by the system event queue 530, the event queue 532, and the message buffer 534 to facilitate performance of operations on the stored by, or received by, the computing tile 510. For example, the RISC device 536 can include circuitry configured to process commands and/or messages to cause performance of extended memory operations using data stored by, or received by, the computing tile 510. The RISC device 536 may include a single core or may be a multi-core processor.

The computing tile memory 538 can, in some embodiments, be a memory resource such as random-access memory (e.g., RAM, SRAM, etc.). Embodiments are not so limited, however, and the computing tile memory 538 can include various registers, caches, buffers, and/or memory arrays (e.g., 1T1C, 2T2C, 3T, etc. DRAM arrays). The computing tile memory 538 can be configured to receive and store data from, for example, a memory device such as the memory devices 116-1, . . . , 116-N illustrated in FIG. 1, herein. In some embodiments, the computing tile memory 538 can have a size of approximately 256 kilobytes (KB), however, embodiments are not limited to this particular size, and the computing tile memory 538 can have a size greater than, or less than, 256 KB.

The computing tile memory 538 can be partitioned into one or more addressable memory regions. As shown in FIG. 5, the computing tile memory 538 can be partitioned into addressable memory regions so that various types of data can be stored therein. For example, one or more memory regions can store instructions (“INSTR”) 541 used by the computing tile memory 538, one or more memory regions can store data 543-1, . . . , 543-N, which can be used as an operand during performance of an extended memory operation, and/or one or more memory regions can serve as a local memory (“LOCAL MEM.”) 545 portion of the computing tile memory 538. Although twenty (20) distinct memory regions are shown in FIG. 5, it will be appreciated that the computing tile memory 538 can be partitioned into any number of distinct memory regions.

As discussed above, the data can be retrieved from the memory device(s) and stored in the computing tile memory 538 in response to messages and/or commands generated by the orchestration controller (e.g., the orchestration controller 106, 206, 306, 406 illustrated in FIGS. 1-4, herein), and/or a host (e.g., the host 102 illustrated in FIG. 1, herein). In some embodiments, the commands and/or messages can be processed by a media controller such as the media controller 112, 212, 312, or 412 illustrated in FIGS. 1-4, respectively. Once the data are received by the computing tile 510, they can be buffered by the DMA buffer 539 and subsequently stored in the computing tile memory 538.

As a result, in some embodiments, the computing tile 510 can provide data driven performance of operations on data received from the memory device(s). For example, the computing tile 510 can begin performing operations on data (e.g., extended memory operations, etc.) received from the memory device(s) in response to receipt of the data.

For example, because of the non-deterministic nature of data transfer from the memory device(s) to the computing tile 510 (e.g., because some data may take longer to arrive at the computing tile 510 dude to error correction operations performed by a media controller prior to transfer of the data to the computing tile 510, etc.), data driven performance of the operations on data can improve computing performance in comparison to approaches that do not function in a data driven manner.

In some embodiments, the orchestration controller can send a command or message that is received by the system event queue 530 of the computing tile 510. As described above, the command or message can be an interrupt that instructs the computing tile 510 to request a data and perform an extended memory operation on the data. However, the data may not immediately be ready to be sent from the memory device to the computing tile 510 due to the non-deterministic nature of data transfers from the memory device(s) to the computing tile 510. However, once the data is received by the computing tile 510, the computing tile 510 can immediately begin performing the extended memory operation using the data. Stated alternatively, the computing tile 510 can begin performing an extended memory operation on the data responsive to receipt of the data without requiring an additional command or message to cause performance of the extended memory operation from external circuitry, such as a host.

In some embodiments, the extended memory operation can be performed by selectively moving data around in the computing tile memory 538 to perform the requested extended memory operation. In a non-limiting example in which performance of a floating-point add accumulate extended memory operation is requested, an address in the computing tile memory 538 in which data to be used as an operand in performance of the extended memory operation can be added to the data, and the result of the floating-point add accumulate operation can be stored in the address in the computing tile memory 538 in which the data was stored prior to performance of the floating-point add accumulate extended memory operation. In some embodiments, the RISC device 536 can execute instructions to cause performance of the extended memory operation.

As the result of the extended memory operation is transferred to the message buffer 534, subsequent data can be transferred from the DMA buffer 539 to the computing tile memory 538 and an extended memory operation using the subsequent data can be initiated in the computing tile memory 538. By having subsequent data buffered into the computing tile 510 prior to completion of the extended memory operation using the preceding data, data can be continuously streamed through the computing tile in the absence of additional commands or messages from the orchestration controller or the host to initiate extended memory operations on subsequent data. In addition, by preemptively buffering subsequent data into the DMA buffer 539, delays due to the non-deterministic nature of data transfer from the memory device(s) to the computing tile 510 can be mitigated as extended memory operations are performed on the data while being streamed through the computing tile 510.

When the result of the extended memory operation is to be moved out of the computing tile 510 to circuitry external to the computing tile 510 (e.g., to the data NoC, the orchestration controller, and/or the host), the RISC device 536 can send a command and/or a message to the orchestration controller and/or the host, which can, in turn send a command and/or a message to request the result of the extended memory operation from the computing tile memory 538.

Responsive to the command and/or message to request the result of the extended memory operation, the computing tile memory 538 can transfer the result of the extended memory operation to a desired location (e.g., to the data NoC, the orchestration tile, and/or the host). For example, responsive to a command to request the result of the extended memory operation, the result of the extended memory operation can be transferred to the message buffer 534 and subsequently transferred out of the computing tile 510.

FIG. 6 is another block diagram in the form of a computing tile 610 in accordance with a number of embodiments of the present disclosure. As shown in FIG. 6, the computing tile 610 can include a system event queue 630, an event queue 632, and a message buffer 634. The computing tile 610 can further include an instruction cache 635, a data cache 637, a processing device such as a reduced instruction set computing (RISC) device 636, a computing tile memory 638 portion, and a direct memory access buffer 639. The computing tile 610 shown in FIG. 6 can be analogous to the computing tile 510 illustrated in FIG. 5, however, the computing tile 610 illustrated in FIG. 6 further includes the instruction cache 635 and/or the data cache 637. In some embodiments, the computing tile 610 shown in FIG. 6 can function as an orchestration controller (e.g., the orchestration controller 106, 206, 306, 406 illustrated in FIGS. 1-4, herein).

The instruction cache 635 and/or the data cache 637 can be smaller in size than the computing tile memory 638. For example, the computing tile memory can be approximately 256 KB while the instruction cache 635 and/or the data cache 637 can be approximately 32 KB in size. Embodiments are not limited to these particular sizes, however, so long as the instruction cache 635 and/or the data cache 637 are smaller in size than the computing tile memory 638.

In some embodiments, the instruction cache 635 can store and/or buffer messages and/or commands transferred between the RISC device 636 to the computing tile memory 638, while the data cache 637 can store and/or buffer data transferred between the computing tile memory 638 and the RISC device 636.

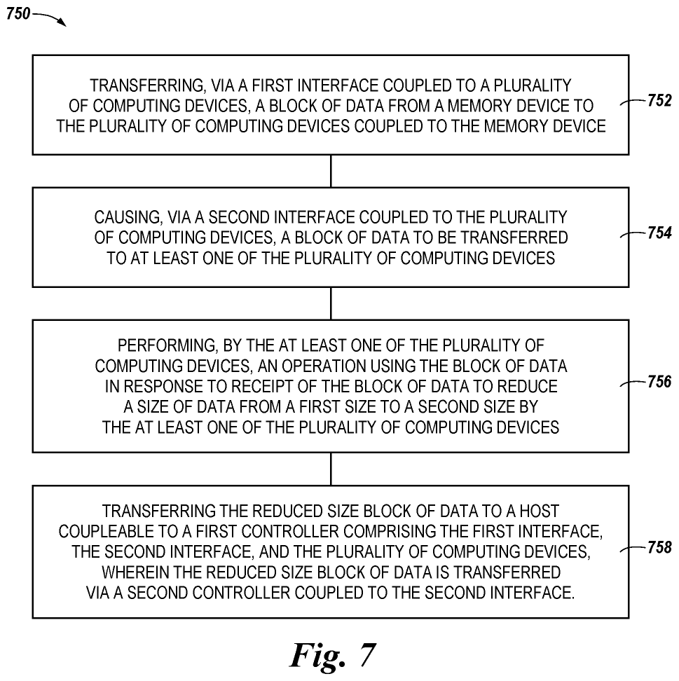

FIG. 7 is a flow diagram representing an example method 750 for extended memory operations in accordance with a number of embodiments of the present disclosure. At block 752, the method 750 can include transferring, via a first interface (e.g., a data NoC) coupled to a plurality of computing devices (e.g., computing tiles), a block of data from a memory device to the plurality of computing devices (e.g., computing tiles) coupled to the memory device. The plurality of computing devices can be each coupled to one another and can each include a processing unit and a memory array configured as a cache for the processing unit. The computing devices can be analogous to the computing tiles 110, 210, 310, 410, 510, 610 illustrated in FIGS. 1-6, herein. The transferring of the block of data can be in response to receiving a request to transfer the block of data in order to perform an operation. In some embodiments, receiving the command to initiate performance of the operation can include receiving an address corresponding to a memory location in the particular computing device in which the operand corresponding to performance of the operation is stored. For example, as described above, the address can be an address in a memory portion (e.g., a computing tile memory such as the computing tile memory 538, 638 illustrated in FIGS. 5 and 6, herein) in which data to be used as an operand in performance of an operation is stored.

At block 754, the method 750 can include causing, via a second interface (e.g., a control NoC) coupled to the plurality of computing devices, a block of data to be transferred to at least one of the plurality of computing devices. The block of data can be transferred from a memory device via a memory controller and be transferred to the at least one of the computing devices by the second interface.

At block 756, the method 750 can include performing, by the at least one of the plurality of computing devices, an operation using the block of data in response to receipt of the block of data to reduce a size of data from a first size to a second size by the at least one of the plurality of computing devices. The performance of the operation can be caused by a controller tile (such as an orchestration controller that is one of the plurality of computing devices). The controller tile can be analogous to the orchestration controller 106, 206, 306, 406 illustrated in FIGS. 1-4, herein. In some embodiments, performing the operation can include performing an extended memory operation, as described herein. The operation can further include performing, by the particular computing device, the operation in the absence of receipt of a host command from a host coupleable to the controller. In response to completion of performance of the operation, the method 750 can include sending a notification to a host coupleable to the controller.

At block 758, the method 750 can include transferring the reduced size block of data to a host coupleable to a first controller (e.g., a storage controller). The first controller can include a first interface (e.g., a control NoC), a second interface (e.g., a data NoC), and the plurality of computing devices (e.g., computing tiles). The method 750 can further include causing, using a third controller (e.g., media controller), the blocks of data to be transferred from the memory device to the first interface. The method 750 can further include allocating, via the second interface, resources corresponding to respective computing devices among the plurality of computing devices to perform the operation on the block of data.

In some embodiments, the command to initiate performance of the operation can include an address corresponding to a location in the memory array of the particular computing device and the method 750 can include storing a result of the operation in the address corresponding to the location in the particular computing device. For example, the method 750 can include storing a result of the operation in the address corresponding to the memory location in the particular computing device in which the operand corresponding to performance of the operation was stored prior to performance of the extended memory operation. That is, in some embodiments, a result of the operation can be stored in the same address location of the computing device in which the data that was used as an operand for the operation was stored prior to performance of the operation.

In some embodiments, the method 750 can include determining, by the orchestration controller, that the operand corresponding to performance of the operation is not stored by the particular computing tile. In response to such a determination, the method 750 can further include determining, by the orchestration controller, that the operand corresponding to performance of the operation is stored in a memory device coupled to the plurality of computing devices. The method 750 can further include retrieving the operand corresponding to performance of the operation from the memory device, causing the operand corresponding to performance of the operation to be stored in at least one computing device among the plurality of computing device, and/or causing performance of the operation using the at least one computing device. The memory device can be analogous to the memory devices 116 illustrated in FIG. 1.

The method 750 can, in some embodiments, further include determining that at least one sub-operation is to be performed as part of the operation, sending a command to a computing device different than the particular computing device to cause performance of the sub-operation, and/or performing, using the computing device different than the particular computing device, the sub-operation as part of performance of the operation. For example, in some embodiments, a determination that the operation is to be broken into multiple sub-operations can be made and the controller can cause different computing devices to perform different sub-operations as part of performing the operation. In some embodiments, the orchestration controller can, in concert with a communications subsystem, such as the control and/or data NoCs 108-1, 208-1, 308-1, 408-1, 108-2, 208-2, 308-2, 408-2, respectively, illustrated in FIGS. 1-4, herein, assign sub-operations to two or more of the computing devices as part of performance of the operation.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a plurality of computing devices coupled to one another and that each comprise:
a processing unit configured to perform an operation on a block of data in response to receipt of the block of data; and
a memory array configured as a cache for the processing unit;
a first communication subsystem within the apparatus and coupled to the plurality of computing devices and to a controller, wherein the first communication subsystem is configured to request the block of data; and
a second communication subsystem within the apparatus and coupled to the plurality of computing devices and to the controller, wherein the second communication subsystem is configured to transfer, within the apparatus, the block of data from the controller to at least one of the plurality of computing devices.

2. The apparatus of claim 1, further comprising an additional controller, wherein the computing tiles, the first communication subsystem, and the second communication subsystem are coupled with the additional controller.

3. The apparatus of claim 1, further comprising the controller coupled to the first communication subsystem and the second communication subsystem and comprising circuitry configured to send the block of data to the first communication subsystem.

4. The apparatus of claim 1, further comprising an additional controller configured to transfer commands associated with the block of data from a host to the first communication subsystem and the second communication subsystem.

5. The apparatus of claim 4, further comprising logic coupled to the additional controller and configured to perform one or more additional operations on the block of data prior to an operation performed by one of the computing devices.

6. The apparatus of claim 4, wherein at least one computing device of the plurality of computing devices comprises the additional controller.

7. The apparatus of claim 1, wherein the communication subsystem comprises a network on a chip (NoC) or a crossbar (XBAR), or both.

8. The apparatus of claim 1, wherein the processing unit of each computing device is configured with a reduced instruction set architecture.

9. The apparatus of claim 1, wherein the operation performed on the block of data comprises an operation in which at least some of the data is ordered, reordered, removed, or discarded, a comma-separated value parsing operation, or both.

10. An apparatus, comprising:
a first computing device comprising a first processing unit and a first memory array configured as a cache for the first processing unit;
a second computing device comprising a second processing unit and a second memory array configured as a cache for the second processing unit;
a first communication subsystem within the apparatus and coupled to the first computing device and the second computing device, wherein the first communication subsystem is configured to request, within the apparatus, a block of data;
a second communication subsystem within the apparatus and coupled to the first computing device and the second computing device, wherein the second communication subsystem is configured to transfer, within the apparatus, the block of data from a media device, via a first controller, to at least one of the first and the second computing devices; and
a second controller coupled to the first communication subsystem and the second communication subsystem, wherein the second controller is configured to allocate at least one of the first computing device and the second computing device to perform an operation on the block of data.

11. The apparatus of claim 10, wherein:
the first communication subsystem sends an instruction to one of the first computing device and the second computing device to be executed on the one of the first computing device and the second computing device; and
the instruction is from one of a host, a different computing device, and a media controller.

12. The apparatus of claim 10, wherein:
the first communication subsystem sends a request for the block of data to be:
transferred from the first controller to one of the first and the second computing devices; or
transferred to the first controller from one of the first and the second computing devices.

13. The apparatus of claim 10, wherein:
the first communication subsystem sends a request for the block of data to be:
transferred from a host to one of the first and the second computing devices; or
transferred to a host from one of the first and the second computing devices.

14. The apparatus of claim 10, wherein the first controller is configured to perform copy, read, write, and error correction operations for a memory device coupled to the apparatus.

15. The apparatus of claim 10, wherein the first computing device and the second computing device are configured such that:
the first computing device can access, through the first communication subsystem, an address space associated with the second computing device; and
the second computing device can access, through the first communication subsystem, an address space associated with the first computing device.

16. The apparatus of claim 10, wherein the first processing unit and the second processing unit are configured with a respective reduced instruction set computing architecture.

17. The apparatus of claim 10, wherein the operation comprises an operation in which at least some data is ordered, reordered, removed, or discarded.

18. A system, comprising:
a host;
a memory device; and
a first controller coupled to the host and the memory device, wherein the first controller comprises:
a first communication subsystem configured to send and receive, within the first controller, instructions to be executed;
a second communication subsystem configured to transfer, within the first controller, data; and
a plurality of computing devices;
wherein the storage controller is configured to:
send, via the first communication subsystem, an instruction from the host to at least one of the plurality of computing devices to perform an operation on a black of data;
transfer, via the second communication subsystem, the block of data from the memory device to the least one of the plurality of computing devices.

19. The system of claim 18, wherein at least one additional computing device of the plurality of computing devices comprises a second controller and the second controller transfers the instruction from a host to the first communication subsystem.

20. The system of claim 19, wherein the second controller is configured to allocate and de-allocate computing resources to the plurality of computing devices to perform the operation on the block of data.

21. The system of claim 18, wherein the first controller is further configured to transfer, via the second communication subsystem, the block of data having the reduced size associated therewith to the memory device.

22. The system of claim 18, wherein the operation on the block of data comprises an operation to reduce a size of the block of data from a first size to a second size, a gather-scatter operation, or both.

23. The apparatus of claim 18, wherein the memory device comprises a NAND memory device or a 3D XPoint memory device, or combinations thereof.

24. A method, comprising:
transferring, via a first communication subsystem coupled to a plurality of computing devices, a block of data from a memory device to the plurality of computing devices coupled to the memory device;
causing, via a second communication subsystem coupled to the plurality of computing devices, a block of data to be transferred to at least one of the plurality of computing devices;
performing, by the at least one of the plurality of computing devices, an operation using the block of data in response to receipt of the block of data to reduce a size of data from a first size to a second size by the at least one of the plurality of computing devices; and
transferring the reduced size block of data to a host coupleable to a first controller comprising the first communication subsystem, the second communication subsystem, and the plurality of computing devices,
wherein the reduced size block of data is transferred via a second controller coupled to the second communication subsystem.

25. The method of claim 24, further comprising causing, using a third controller, the blocks of data to be transferred from the memory device to the first communication subsystem.

26. The method of claim 25, further comprising performing, via the third controller:
read operations associated with the memory device;
copy operations associated with the memory device; and
error correction operations associated with the memory device; or combinations thereof.

27. The method of claim 24, further comprising allocating, via the second communication subsystem, resources corresponding to respective computing devices among the plurality of computing devices to perform the operation on the block of data.
